(19) United States
(12) Patent Application Publication
(10) Pub. No.: US 2026/0004164 A1
(43) Pub. Date: Jan. 1, 2026

(54) PROVIDING INTERMEDIATE RESPONSE DATA IN ASSOCIATION WITH ARTIFICIAL INTELLIGENCE RESPONSES

(71) Applicant: Microsoft Technology Licensing, LLC, Redmond, WA (US)

(72) Inventors: Daniel Alan PAGAN, Kirkland, WA (US); Hemanth Srinivasa REDDY, Bothell, WA (US); Maxim VAINSTEIN, Woodinville, WA (US); Yulia PAKMAN, Issaquah, WA (US)

(21) Appl. No.: 18/759,131

(22) Filed: Jun. 28, 2024

(51) Int. Cl. G06N 5/04

(52) U.S. Cl. CPC G06N 5/04

(57) ABSTRACT

Methods, computer systems, and computer storage media are provided for providing intermediate response data in association with AI responses. In embodiments, an input prompt provided via a user interface is obtained. Based on the input prompt, intermediate response data used to generate an artificial intelligence (AI) response to the input prompt is identified. Such intermediate response data may include context data, query data, source data, and/or query results data. Such intermediate response data may be provided for presentation, via the user interface, in association with the AI response. In this way, a user may be provided with information related to a manner in which the AI response is generated.

### BACKGROUND

Artificial intelligence (AI) assistants are commonly used tools used to enhance productivity. To perform various tasks, AI assistants generally perform complex decision-making processes. Such decision-making processes, however, are not transparent to a user, which may result in distrust in results provided by the AI assistant. In this way, a user may not understand why an AI assistant made a particular recommendation or decision and, as such, have concerns related to the trustworthiness of the information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for providing intermediate response data in association with AI responses. Among other things, embodiments described herein efficiently and effectively provide intermediate response data for presenting via a user interface in accordance with generating and/or providing an AI response. In this manner, a user who initiates the generation of an AI response can be shown the intermediate data used to derive the final response. Specifically, as the AI response is being generated and/or presented, the intermediate data that aids in creating the response may be identified and displayed to the user. Presenting this intermediate data offers context and insight into the analysis performed by the AI assistant manager, helping the user understand how the AI response is generated. In particular, the intermediate response data provides a visualization of information that shows the reasoning process being performed in association with an AI assistant.

### BRIEF DESCRIPTION OF DRAWINGS

The technology described herein is described in detail below with reference to the attached drawing figures, wherein:

FIG. 1 is a block diagram of an exemplary system for providing intermediate response data in association with AI responses, suitable for use in implementing aspects of the technology described herein;

FIG. 2 is an example implementation for providing intermediate response data in association with AI responses, via an AI assistant manager, in accordance with aspects of the technology described herein;

FIG. 3 provides an example user interface for providing intermediate response data in association with AI responses, in accordance with aspects of the technology described herein;

FIG. 4 provides an example method flow for providing intermediate response data in association with AI responses, in accordance with aspects of the technology described herein;

FIG. 5 provides another example method flow for providing intermediate response data in association with AI responses, in accordance with aspects of the technology described herein;

FIG. 6 provides another example method flow for providing intermediate response data in association with AI responses, in accordance with embodiments described herein;

FIG. 7 is a block diagram of an exemplary computing environment suitable for use in implementing aspects of the technology described herein; and

FIG. 8 is a block diagram of an exemplary large language model environment suitable for use in implementing aspects of the technology described herein.

### DETAILED DESCRIPTION

The technology described herein is described with specificity to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Intelligent assistants, also referred to as AI assistants, generally use AI to perform tasks, provide services, and assist users in various ways. An intelligent assistant or AI assistant generally refers to any use of AI technology that may perform tasks or services based on input. In embodiments, the technology may perform tasks facilitated through AI technology, such as natural language processing, machine learning, or other AI technologies. For example, an AI assistant may perform task automation, information retrieval, and/or the like. While an AI assistant provides various information in an understandable manner, a user viewing the information may not consider the information trustworthy. As one example, a user may be concerned about accuracy and reliability of the presented information (e.g., incorrect or misleading information due to errors in the algorithm, outdated data sources, or the like). As another example, a user may be concerned about bias and fairness in the data presented. In particular, as the decision-making processes of AI assistants are often complex, a user may not understand why an AI assistant made a particular recommendation or decision and, as such, have concerns related to the trustworthiness of the information.

In addition to the lack of transparency in the decision-making processes resulting in a lack of trust in information provided by an AI assistant, computing resources may be unnecessarily consumed in order for a user to more confidently trust the information. For example, in accordance with an AI assistant providing information, the user may initiate additional requests for information in an effort to verify the quality of the information. In this regard, to fully trust the provided information, a user may continue searching for desired information by generating and submitting new prompts to be input to an AI model, such as a large language model (LLM), thereby using computing resources to perform additional processing. As obtaining desired information may be time-consuming and burdensome, particularly when multiple search iterations are performed, computing and networking resources are unnecessarily consumed to facilitate the search for information. For instance, computer input/output (I/O) operations are unnecessarily multiplied in an effort to identify particular information. In this regard, an excessive quantity of prompts executed to find information can unnecessarily result in decreased throughput and increased network latency, thereby increasing usage of computing and network resources.

Embodiments described herein efficiently and effectively provide intermediate response data for presenting via a user interface in accordance with generating and/or providing an AI response. In this way, a user that initiates generation of an AI response may be provided with intermediate response data used in deriving the AI response presented to the user. In particular, as an AI response is being generated and/or presented, intermediate response data facilitating the generation of the AI response may be identified and presented to the user. Presentation of such intermediate response data provides context and understanding of analysis being performed in association with an AI assistant manager such that the user may understand a manner in which the AI response is generated.

By way of example, an AI assistant manager may generate and/or use various application programming interfaces (APIs), queries, skills, data sources, data compilation approaches, or the like to generate a response. In accordance with embodiments described herein, intermediate response data providing context or understanding as to how the response is generated is presented or displayed to a user. Various types of intermediate response data that may be presented include, without limitation, intermediate queries, raw query results, skills, intent, and/or the like. In this way, information that would otherwise not be available to be viewed or understood by a user can facilitate a trustworthy response. As one example, the AI assistant manager may provide a response that does not contain all the information surfaced as raw query results (e.g., based on analysis and/or aggregation performed by the AI assistant manager). Providing such omitted raw query results as intermediate response data may enable the user to better understand how the AI assistant manager compiled the data and, as such, improve the user's trust in the response and the AI assistant manager.

As can be appreciated, such an understanding of aspects related to how an AI response is generated provides more reliability and trustworthiness of the AI response. Advantageously, in instances in which a user more readily understands the intermediate response data used in facilitating an AI response, the need to generate additional AI queries and/or responses may be reduced as the user may be more confident in the initial AI response presented. As such, embodiments described herein reduce utilization of computer resources that would otherwise be used to repetitively generate AI responses (e.g., in an effort to ensure the user trusts the response).

Further, in accordance with embodiments described herein, user feedback may be obtained in association with intermediate response data to facilitate providing intermediate response data and/or AI responses in an effective and efficient manner. For example, in some embodiments, a user may provide feedback indicating preferences related to the presentation of intermediate response data. In this way, the user feedback may modify presentation of the intermediate response data (e.g., for a current AI response and/or subsequent AI responses), such as the type of intermediate response data presented and/or a format or manner in which the intermediate response data is presented. Additionally or alternatively, a user may provide feedback indicating preferences related to the utilization of intermediate response data. In this way, the user feedback may modify what type of intermediate response data is used to generate an AI response, or how to use intermediate response data (e.g., for a current AI response and/or subsequent AI response). Obtaining and using such user feedback in association with intermediate response data facilitates a more desired or tailored generation and/or presentation of data for the user, thereby providing a better user experience. Further, such feedback may further reduce utilization of computer resources that would otherwise be used to repetitively generate AI responses (e.g., in an effort to ensure the user trusts the response or obtains a desired response).

### Overview of Exemplary Environments for Providing Intermediate Response Data in Association With AI Responses

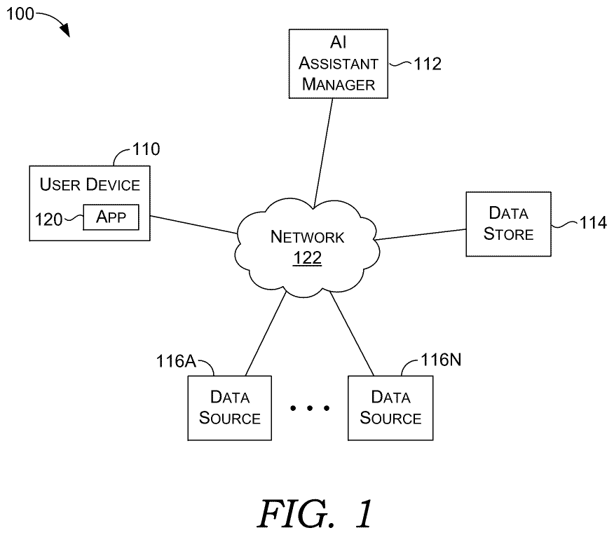

Referring initially to FIG. 1, a block diagram of an exemplary network environment 100 suitable for use in implementing embodiments described herein is shown. Generally, the system 100 illustrates an environment suitable for providing intermediate response data in association with AI responses. Among other things, embodiments described herein efficiently and effectively provide intermediate response data for presenting via a user interface in accordance with generating and/or providing an AI response. In this way, a user that initiates generation of an AI response may be provided with intermediate response data used in deriving the AI response presented to the user. In particular, as an AI response is being generated and/or presented, intermediate response data facilitating the generation of the AI response may be identified and presented to the user. Presentation of such intermediate response data provides context and facilitates understanding of analysis being performed in association with an AI assistant manager such that the user may understand a manner in which the AI response is generated.

Further, user feedback may be obtained in association with intermediate response data to facilitate providing intermediate response data and/or AI responses in an effective and efficient manner. For example, a user may provide feedback indicating preferences related to the presentation of intermediate response data. In this way, the user feedback may modify presentation of the intermediate response data (e.g., for a current AI response and/or subsequent AI responses), such as the type of intermediate response data presented and/or a format or manner in which the intermediate response data is presented. Additionally or alternatively, a user may provide feedback indicating preferences related to the utilization of intermediate response data. As such, the user feedback may modify what type of intermediate response data is used to generate an AI response, or how intermediate response data is used (e.g., for a current AI response and/or subsequent AI response).

The network environment 100 includes a user device 110, an AI assistant manager 112, a data store 114, and data sources 116a-116n (referred to generally as data source[s] 116). The user device 110, the AI assistant manager 112, the data store 114, and the data sources 116a-116n can communicate through a network 122, which may include any number of networks such as, for example, a local area network (LAN), a wide area network (WAN), the Internet, a cellular network, a peer-to-peer (P2P) network, a mobile network, or a combination of networks. The data store 114 may store any type or amount of data, including data accessible to the user device 110, the AI assistant manager 112, and/or the data sources 116. For example, the data store 114 may store prompts, queries, context data, responses, intermediate response data, user feedback, and/or the like.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the AI assistant manager 112 via a mobile network or the Internet, and the AI assistant manager 112 may be in communication with data store 114 via a local area network. Further, although the environment 100 is illustrated with a network, one or more of the components may directly communicate with one another, for example, via HDMI (High-Definition Multimedia Interface) and DVI (Digital Visual Interface). Alternatively, one or more components may be integrated with one another, for example, at least a portion of the AI assistant manager 112 and/or data store 114 may be integrated with the user device 110. For instance, a portion of the AI assistant manager 112 may be integrated with the user device (e.g., via application 120).

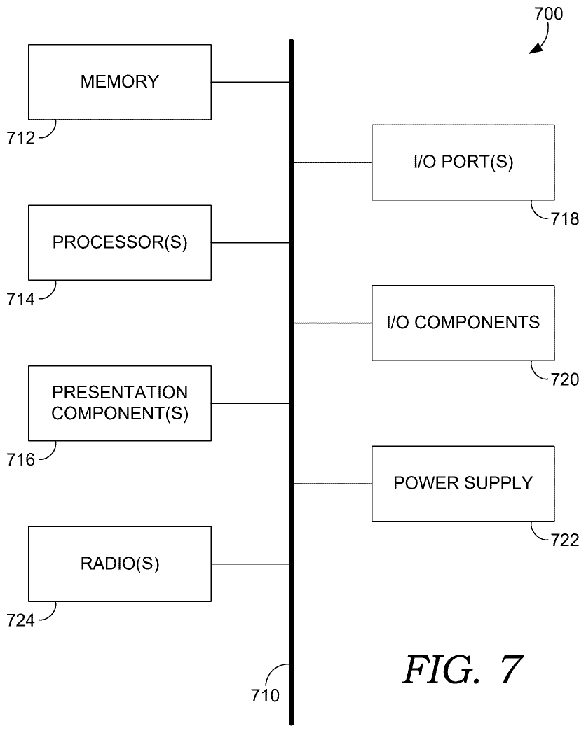

The user device 110 can be any kind of computing device capable of facilitating the generation and/or presentation of AI responses and intermediate data associated therewith. For example, in an embodiment, the user device 110 can be a computing device such as computing device 700, as described above with reference to FIG. 7. In embodiments, the user device 110 can be a personal computer (PC), a laptop computer, a workstation, a mobile computing device, a PDA, a cell phone, or the like.

The user device can include one or more processors and one or more computer-readable media. The computer-readable media may include computer-readable instructions executable by one or more processors. The instructions may be embodied by one or more applications, such as application 120 shown in FIG. 1. The application(s) may generally be any application capable of facilitating the generation and/or presentation of AI responses and intermediate data associated therewith. AI assistant capabilities may be integrated into a variety of applications across various domains, for example, to enhance user productivity, facilitate decision-making, and automate repetitive tasks. Examples of applications may include code editors and integrated development environments, productivity tools and office suites, customer relationship management (CRM) systems, project management software, collaboration platforms, content creation tools, e-commerce platforms, data analysis and business intelligence tools, healthcare applications, or the like. Any of such applications may include an AI assistant tool or technology that may facilitate generating and/or providing AI responses. As such, application 120 may be any type of application that may facilitate generation and/or presentation of AI responses and intermediate response data. One example of an AI assistant functionality or tool that may be included in an application is Microsoft Copilot. In some implementations, the application(s) comprises a web application, which can run in a web browser, and may be hosted at least partially server-side (e.g., via AI assistant manager 112). In addition, or instead, the application(s) can comprise a dedicated application. In some cases, the application is integrated into the operating system (e.g., as a service).

User device 110 can be a client device on a client-side of operating environment 100, while AI assistant manager 112 can be on a server-side of operating environment 100. AI assistant manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted that there is no requirement for each implementation that any combination of user device 110 and/or AI assistant manager 112 remain as separate entities.

In an embodiment, the user device 110 is separate and distinct from the AI assistant manager 112, the data store 114, and the data sources 116 illustrated in FIG. 1. In another embodiment, the user device 110 is integrated with one or more illustrated components. For instance, the user device 110 may incorporate functionality described in relation to the AI assistant manager 112. For clarity of explanation, embodiments are described herein in which the user device 110, the AI assistant manager 112, the data store 114, and the data sources 116 are separate, while understanding that this may not be the case in various configurations contemplated.

As described, a user device, such as user device 110, can facilitate generating and/or presenting intermediate response data in association with AI responses in an effective and efficient manner. Intermediate response data generally includes information that provides an indication of a manner in which an AI response is generated. As such, providing intermediate response data enables a user to understand how an AI response is generated. For example, assume a user inputs a prompt requesting a response. Embodiments described herein enable the AI assistant manager 112 to identify intermediate response data indicating a manner in which an AI response is generated in association with the prompt, which may then be provided to the user for viewing via application 120 of the user device 110.

A user device 110, as described herein, is generally operated by an individual or entity interested in viewing information. In some cases, identification and/or presentation of intermediate response data associated with an AI response may be initiated at the user device 110. For instance, in some cases, a user may navigate to an AI tool interface (e.g., a chat box) and input or select a prompt. As one example, the user input prompt may include or be a natural language input by a user. A user input prompt may include a request in the form of a question, command, or description of a task. Based on the input or initiation of the prompt, identification and/or presentation of intermediate response data associated with an AI response is initiated. For example, a user may navigate to an application, via the Internet, and input a text prompt to obtain an AI response and corresponding intermediate response data relevant thereto. As another example, a user may open a content management service and input a prompt in an input or chat box to obtain corresponding intermediate response data and an AI response.

As described, the user device 110 can include any type of application, which may be a stand-alone application, a mobile application, a web application, or the like. In some cases, the functionality described herein may be integrated directly with an application or may be an add-on, or plug-in, to an application.

The user device 110 may communicate with the AI assistant manager 112 to initiate identification and/or presentation of intermediate response data and/or AI responses. In embodiments, for example, a user may utilize the user device 110 to initiate generation and/or presentation of AI responses and/or intermediate response data associated therewith via the network 122. For instance, in some embodiments, the network 122 may be the Internet, and the user device 110 interacts with the AI assistant manager 112 to initiate identification and/or presentation of intermediate response data and/or AI responses. In other embodiments, for example, the network 122 may be an enterprise network associated with an organization. In yet other embodiments, the AI assistant manager 112 may additionally or alternatively operate locally on the user device 110 to provide local responses. It should be apparent to those having skill in the relevant arts that any number of other implementation scenarios may be possible as well.

With continued reference to FIG. 1, the AI assistant manager 112 can be implemented as server systems, program module(s), virtual machine(s), component(s) of a server or servers, networks, and the like. At a high level, the AI assistant manager 112 manages artificial intelligence (AI) response functionalities. An AI assistant manager generally refers to a service or engine that performs AI response-related services. In particular, the AI assistant manager receives prompts (e.g., via user input) and, in response, provides AI responses relevant to the prompts. In this regard, in association with obtaining a prompt, the AI assistant manager 112 can identify relevant information and provide the information as a response for presentation in response to the data prompt. An AI response generally refers to a response that is generated using AI technology. Such an AI assistant manager 112 may communicate with application 120 operating on user device 110 to provide back-end services to application 120. Alternatively or additionally, the AI assistant manager 112 can operate at the user device to provide local results.

To generate an AI response, the AI assistant manager 112 may query a data source, such as data source(s) 116A-116N. For example, a query may be generated based on a user input prompt and executed against data source(s) 116 to obtain relevant data, which may then be used to generate an AI response to provide to the user device 110. Data sources 116 may include various content or types of content, such as web documents, images, videos, etc. In some cases, data sources 116 are associated with an application 120 operating on the user device 110. Examples of data sources include a search engine, a content management system, enterprise content, etc. The generated AI response(s) may be provided to the user device for presentation to the user. An AI response may be presented to a user via a user interface associated with application 120 in any number of ways.

In accordance with embodiments described herein, the AI assistant manager 112 alternatively or additionally identifies and/or provides intermediate response data. In particular, data that is used to facilitate generation of an AI response is identified and provided for presentation to the user to provide the user with context or understanding of the development of the AI response. As such, upon obtaining a particular user input prompt, various types of intermediate response data that is or may be used to generate an AI response relevant to the prompt may be identified. As described herein, various types of intermediate response data may be identified and presented to a user. By way of example only, types of intermediate response data that may be presented include context data (e.g., intent and/or skills), query data, source data, query results data, and/or the like. In accordance with identifying such intermediate response data, the intermediate response data may be presented to the user via the user device (e.g., by way of application 120). For example, a query(s) generated and a data source(s) to be searched may be identified and presented to the user. In some cases, intermediate response data is presented as it is generated. In this way, intermediate response data may be presented prior to the AI response being generated and presented. In other cases, intermediate response data may be presented along with the AI response, or as the AI response is being presented. Advantageously, intermediate response data provides a trust-focused approach for conveying information used to facilitate generation of an AI response. In this way, a user can understand the development of an AI response in a more effective and comprehensive manner.

Further, as described herein, the AI assistant manager 112 enables user feedback in relation to intermediate response data. User feedback may be obtained in association with intermediate response data to facilitate providing intermediate response data and/or AI responses in an effective and efficient manner. For example, in some embodiments, a user may provide feedback indicating preferences related to the presentation of intermediate response data. In this way, the user feedback may modify presentation of the intermediate response data (e.g., for a current AI response and/or subsequent AI responses), such as the type of intermediate response data presented and/or a format or extent in which the intermediate response data is presented. Additionally or alternatively, a user may provide feedback indicating preferences related to the utilization of intermediate response data. In this way, the user feedback may modify what type of intermediate response data is used to generate an AI response, or how intermediate response data is used (e.g., for a current AI response and/or subsequent AI response). Obtaining and using such user feedback in association with intermediate response data facilitates a more desired or tailored generation and/or presentation of data for the user, thereby providing a better user experience.

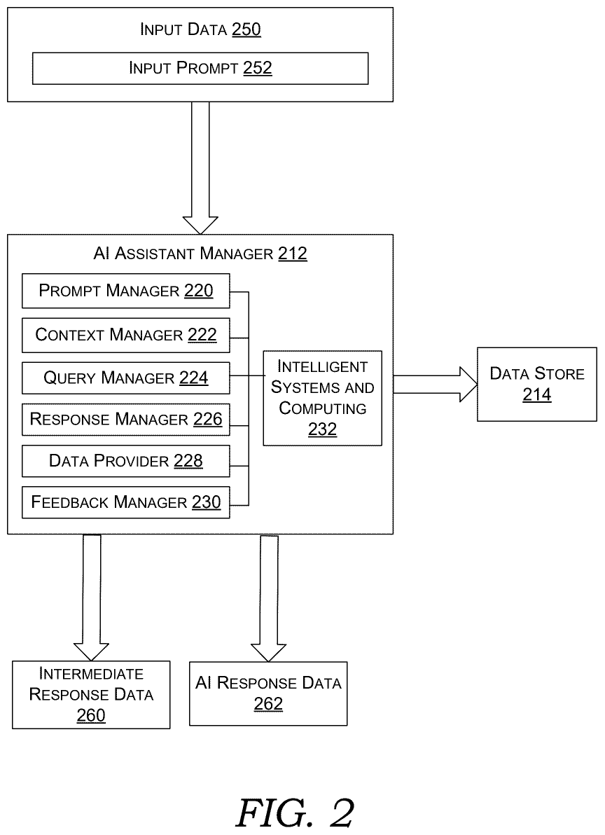

Turning now to FIG. 2, FIG. 2 illustrates an example implementation for identifying and/or presenting intermediate response data in association with AI responses via AI assistant manager 212. The AI assistant manager 212 is communicatively coupled with the data store 214. The data store 214 is configured to store various types of information accessible by the AI assistant manager 212 or other server. In embodiments, data sources (such as data sources 116 of FIG. 1), user devices (such as user devices 110 of FIG. 1), and/or AI assistant manager (such as AI assistant manager 112 of FIG. 1) can provide data to the data store 214 for storage, which may be retrieved or referenced by any such component. As such, the data store 214 may store query data, context data, source data, query results data, intermediate response data, AI response data, content items (e.g., documents, such as web documents, images, or the like), and/or the like.

In operation, the AI assistant manager 212 is generally configured to manage identifying and/or presenting AI responses and intermediate response data associated therewith in an efficient and effective manner. In embodiments, the AI assistant manager 212 includes a prompt manager 220, a context manager 222, a query manager 224, a response manager 226, a data provider 228, a feedback manager 230, and intelligent systems and computing 232. According to embodiments described herein, the AI assistant manager 212 can include any number of other components not illustrated. In some embodiments, one or more of the illustrated components 220, 222, 224, 226, 228, 230, and 232 can be integrated into a single component or can be divided into a number of different components. Components 220, 222, 224, 226, 228, 230, and 232 can be implemented on any number of machines and can be integrated, as desired, with any number of other functionalities or services.

Initially, intelligent systems and computing 232 may include any type of technology that may be used by any component(s) of the AI assistant manager 212 to facilitate AI response and/or intermediate response data generation and/or presentation. Various types of technology may include natural language processing technology, large language models, small language models, rules, algorithms, artificial intelligence, machine learning, or other computing technologies. Some of such technologies are described herein in association with the various components, but embodiments are not intended to be limited herein. Further, although illustrated as a separate component, various technologies may be incorporated or included in association with the corresponding component. For example, the response manager 226 may be or include an LLM.

The prompt manager 220 is generally configured to manage a prompt. A prompt, or input prompt, generally refers to a user input seeking an AI response. In this regard, a prompt may include input or stimulus provided by a user (or other system component) that initiates or guides a response from AI. By way of example only, a user may provide a prompt of “Find the latest news on electric cars.” A prompt may generally provide details to guide AI toward a desired response. Oftentimes, a prompt includes contextual information that facilitates understanding of the setting or background of the request or desired response. Prompts may vary in complexity and form. User input may be provided in any type of input modality, such as typed text, speech, or the like. Further, text, audio, video, or the like may be provided as input, and such content input is not intended to be limited herein.

The prompt manager 220 may obtain a prompt. As described, a prompt may be obtained based on input provided via a user device. In some cases, the prompt manager 220 may preprocess the input to perform basic text processing. For example, the prompt manager 220 may apply preprocessing techniques to remove noise, normalize text (e.g., converting to lowercase), and tokenize the input into tokens.

The context manager 222 is generally configured to manage context associated with prompts. In this way, the context manager 222 may facilitate understanding specific user needs and intentions in association with an obtained prompt. As such, the context manager 222 may facilitate understanding of details and nuances of content or text in a prompt. For example, the context manager 222 may analyze text provided within the prompt to understand the language, semantics, intent, skill, and/or other context associated with the prompt.

One example of context that may be identified via the context manager 222 is intent associated with the prompt. Intent generally refers to an intent of a user based on the input. In this regard, intent may include understanding or recognizing an underlying goal, purpose, or objective associated with a user's input. As such, the context manager 222 may analyze the input to recognize keywords, phrases, and the overall goal of the user, for example, to understand what the user seeks to achieve or what action is expected to be performed (e.g., via the AI assistant manager). To identify intent, the context manager 222 may use various technologies. For example, the context manager 222 may use intelligent systems and computing 232 to facilitate identification of intent. Such technologies to identify may include, but are not limited to, natural language processing, machine learning, AI, and/or contextual analysis.

By way of example only, to understand user intent associated with a prompt, an LLM or natural language processing (NLP) model may process a prompt input to understand an intent associated therewith. In this regard, various aspects may be identified. For instance, the input may be analyzed to identify a main action (“find”) and a subject (“latest news on electric cars”). As one example, natural language understanding may be used to parse intent (“find”) and entities “latest news on electric cars”). In some cases, an LLM may be used to process user input and understand intent behind the prompt. Intent may be represented in any number of ways. For instance, intent may be represented using a sentence(s), phrase(s), keyword(s), or the like. As one particular example, intent may be represented (e.g., after cleaning and tokenizing) as [“find,” “the,” “latest,” “news,” “on,” “electric,” “cars”].

The context manager 222 may identify intent in any number of ways. In some cases, determining intent may include text preprocessing to apply tokenization to break down the input into words or tokens and lemmatization or stemming to reduce words to a base or root form. Further, syntactic and semantic analysis may be performed to identify grammatical parts of speech, and named entity recognition may be performed to identify specific entities specified in the prompt. To identify intent, in some cases, an understanding of input based on the current session and/or previous interactions may be used.

The context manager 222 may identify intent based on intent classification, which may be performed using a machine learning model. For instance, a trained model, such as bidirectional encoder representations from transformers (BERT), generative pre-trained transformer (GPT), or a custom classifier, may be used to classify the intent based on the input text. In some cases, intent classification may be performed using a set of predefined intents. Alternatively or additionally, pattern matching and keyword detection may be used. Keyword detection may be used to identify specific keywords or phrases that directly indicate the user's intent. Pattern matching may be used to recognize common patterns in prompts.

In addition to intent, the context manager 222 may identify other types of context associated with a prompt. Additional context may include, for instance, specific topics, types of documents, and/or particular data points. Various technologies (e.g., via intelligent systems and computing 232) may be used to identify such context relevance.

As another example, in some cases, the context manager 222 may identify a skill associated with a prompt. A skill may be identified based on the analyzed prompt and recognized intent. In this way, the context manager 222 may use context, such as intent and other information, to identify a skill. A skill refers to a specific capability or function that can be performed (e.g., via AI technology) to assist a user with various tasks. A particular skill may be designed to address a particular type of request and to provide relevant responses or actions based on the user prompt. In embodiments, a particular skill may be tailored to perform a specific type of task or provide a particular type of assistance, such as writing, coding, data analysis, customer support, etc. By way of example only, various skills may include text summarization (e.g., summarizing text content), code generation (e.g., writing code snippets or functions), data analysis (e.g., analyze datasets to identify trends, generate reports, or visualize data), content creation (e.g., generate text content), task automation (e.g., automate repetitive tasks such as scheduling, email management, or data entry), language translation (e.g., translate text from one language to another), customer support (e.g., provide automated responses to customer inquiries, manage support tickets, or the like), or the like.

A skill may correspond with accessing a data source(s) or API(s) to retrieve information or perform actions. For example, a weather reporting skill may query a weather API. As described, a skill may be used to enable the AI to interpret user inputs accurately, generate relevant queries, and/or deliver appropriate responses or actions, thereby enhancing user productivity and efficiency across various domains.

To determine a skill, the context manager 222 may use various types of technology, for example, via intelligent systems and computing 232. In particular, a skill may leverage various types of technologies depending on the type of skills, such as natural language processing, machine learning, data retrieval, task automation, and/or the like. As one example, AI may be used to select a relevant, or most relevant, skill (e.g., from a skill repository) to address a prompt. Various context data may be used to identify a skill(s) in association with a prompt. For example, in addition to using intent to identify a skill, certain keywords or phrases in a prompt and/or specific details in the prompt (such as the type of document, programming language, or the like) may trigger a specific skill. Further, the context manager 222 (e.g., via AI) may use previous interactions or additional contextual information provided in the session to refine its skill selection.

By way of example only, the context manager 222 may use a classifier to determine that the appropriate skill needed is web search. In some cases in which an ongoing session or past query exists, the context manager 222 may retrieve such context to ensure continuity and relevance in handling the request. To perform skill classification, the context manager 222 may use, for example, AI, an LLM, a rule-based system, or other machine learning mode to classify intent and match it to an appropriate skill.

In embodiments, such context data identified in association with context manager 222 may be used by other components of the AI assistant manager 212 to perform various AI assistant tasks, such as to provide a response or intermediate response data in association therewith. For example, and as described herein, the query manager 224 may use an intent identified in association with a prompt to generate a query. As another example, the query manager 224 may use an identified skill in association with a prompt to generate a query or identify a data source. As yet another example, the response manager 226 may use an identified intent or skill, or other context data, to generate a response to the prompt. Accordingly, the context data identified may be provided to other components of the AI assistant manager 212 or made available to other components (e.g., via data store 214).

In accordance with embodiments described herein, context data, such as intent and skill identified in association with a prompt, may be provided to the data provider 228, which facilitates providing intermediate response data to the user device. In this way, the context data may be provided as intermediate response data as such context data may be deemed relevant to providing an understanding of how an AI response is generated.

The query manager 224 is generally configured to manage query generation and/or execution thereof. A query generally refers to a request for data from which an AI response may be generated. In this regard, a query may be used to retrieve relevant information, perform specific tasks, or provide accurate responses based on the user's input. Generally, a query is a specific request or question formulated, for example by an AI assistant manager, based on the user's input prompt. The prompt provided by the user may provide a basis for formulating a query to be executed. In this way, the query manger 224 may use the input prompt 252 of input data 250 to derive the query. For example, the query manager 224 may perform additional processing or refinement of a prompt to convert the prompt or generate a query in a format that is suitable for the specific task or informant retrieval.

To generate a query suitable to generate a desired AI response, the query manager 224 may use context data, for example, generated via context manager 222. For example, in one example, user intent may be used to formulate a query. In this way, user intent may be added to the query or used to modify the query. In another example, a skill may be used to formulate the query. By way of example only, the query manager 224 may generate a structured query by incorporating an identified intent and entities extracted in association with a prompt input by a user.

In addition to generating a query, the query manager 224 may be configured to identify a data source associated with the query. For example, a data source may be identified to recognize a source to which to provide the query to obtain relevant data. Various data sources may include internal enterprise data source (e.g., document repository, database, email and calendar, CRM system, enterprise resource planning [ERP] system), cloud services (e.g., leveraging for data storage, machine learning models, or other cloud-based resources), public data sources (e.g., web search engines, public APIs and web services, open data repositories), applications (e.g., productivity applications, collaboration applications, communication applications), AI and machine learning models (e.g., pre-trained models or custom models), knowledge bases and documentation (e.g., wikis, repositories, manuals, user guides) and/or the like. Any granularity of a data source may be identified by the query manager 224. For example, in some cases, a document repository may be identified and, in other cases, a particular set of documents may be identified.

To identify a data source, the query manager 224 may use context data, such as context data identified via context manager 222. For instance, query manager 224 may analyze user intent and other context (e.g., a skill) associated with a prompt to identify a data source or set of data sources associated with the query (e.g., for use in identifying relevant data). In accordance with identifying a data source, in some cases, the query manager 224 may include the data source as part of the query. For instance, the query may be generated to include an indication of a relevant data source(s) for use in executing the query.

The query manager 224 may include or use various types of technology (e.g., intelligent systems and computing 234) to generate a query and/or identify a data source. For instance, an LLM may be used to facilitate generation of a query. An LLM may be used to enhance a query by structuring, rephrasing, or optimizing a query to improve search results.

The query manager 224 may also initiate execution of a query. In this way, the query manager 224 may communicate the generated query to a data source(s), such as a data source(s) identified as relevant. For example, assume a particular search engine is identified as a data source to provide relevant data. In such a case, the query manager 224 may provide the query to the particular search engine. In embodiments, the query manager 224 may use or call an API to communicate the query. For example, a search engine API may be called to obtain relevant data.

In accordance with embodiments described herein, the query manager 224 may provide various data to the data provider 228 that facilitates providing data to the user device. Such data to provide may include a generated query, an identified data source for use in executing a query, and/or an identified API for use in executing a query. Any amount or type of query data may be provided. For instance, multiple queries may be generated to search different data sources. In such a case, the various queries and data sources may be provided to the data provider 228. Accordingly, query data (e.g., a query and/or data source) may be provided as intermediate response data to reflect a manner in which an AI response is generated or is to be generated.

The response manager 226 is generally configured to facilitate generation of an AI response. As described, an AI response refers to a response generated using AI. In this regard, the response manager 226 may use or access AI (e.g., via intelligent systems and computing 232) to facilitate generation of a response to an input prompt provided by a user. To generate an AI response, the response manager 226 may obtain query results. That is, data or results obtained in response to executing the query generated by query manager 224 may be obtained by the response manager 226. As can be appreciated, any amount or relevance of query results may be obtained. In some cases, the query results data may be analyzed or preprocessed to identify which query results data to use in generating an AI response. The query results may then be used by an AI model, such as an LLM, to generate a response to be provided to a user.

A query result may be in any form. In some cases, the form of a query result may depend on the data source providing the query result. For example, a search engine may provide a query result in one format (e.g., title, URL, and snippet), while a data repository may provide a query result in a different format. In some cases, a query result may be in the form of a JSON or XML data format.

In accordance with embodiments described herein, query results data may be provided to the data provider 228, which facilitates providing intermediate response data to the user device. In this way, the query results data may be provided as intermediate response data as query results data may be deemed relevant to providing an understanding of how an AI response is generated. For instance, a user may desire to view raw query results from which an AI response is generated. In some cases, the raw query results may provide results that were not used to generate the AI response, which may be valuable to a user to view.

The response manager 226 may use any type of data to generate an AI response. For example, the query results data may be used along with various context data such as the intent and skill associated with the user input prompt. In one embodiment, the response manager 226 may compile search results into a user-friendly response. For instance, an AI response may be generated that includes a summary of top articles, the sources, and links in a formatted manner.

In some cases, an LLM or other AI model may be used to compile and summarize the obtained query results, or portion thereof. An LLM may format the response in natural language, thereby making information easier to understand and more engaging for a user. In operation, in some cases, the response manager 226 may generate an AI prompt that is input into an AI model (e.g., an LLM) to obtain an AI response. For example, the response manager 226 may include query results data, the user input prompt, the query, context data (e.g., skill and/or intent), and/or response instructions (e.g., a length or format for presenting the results), among other things, in an AI prompt structured to be input into an LLM (e.g., via intelligent systems and computing 232) to generate an appropriate AI response. An AI response may be provided to the data provider 228 to be communicated to the user device for presentation to the user.

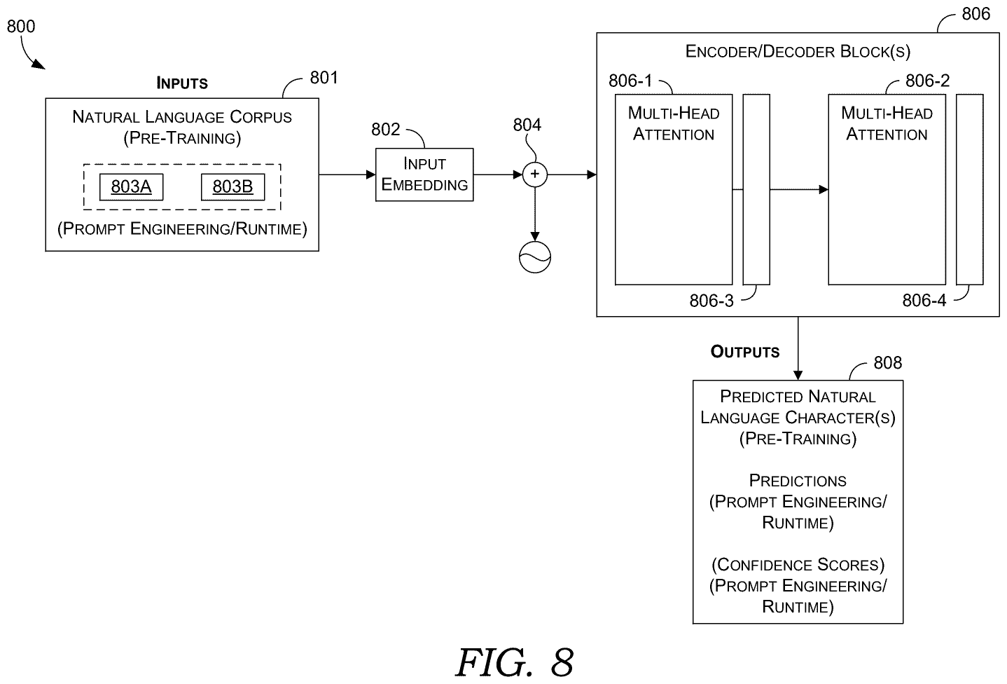

As such, the response manager 226 may be, include, or access any number of machine learning models or technologies. In some embodiments, a machine learning model in the form of an LLM is used to generate an AI response. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model when it is trained on an enormous amount of data. In particular, an LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes—all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images). In some embodiments, the response manager 226 takes on the form of or uses an LLM, but various other machine learning models can additionally or alternatively be used. One example of an LLM is provided below in reference to FIG. 8.

The data provider 228 is generally configured to provide data, such as intermediate response data 260 and AI response data 262. In this regard, the data provider 228 may provide intermediate response data and AI response data to the user device that provided the input prompt 252 to the AI assistant manager 212. In this way, the data provider 228 provides data to be presented that is relevant to the user input prompt. The data provider 228 may provide the AI response and/or intermediate response data to the user device via an appropriate interface (e.g., a chat window, search results page, or the like).

As described, the data provider 228 may provide an AI response and/or intermediate response data. In this way, in addition to presenting a response to the prompt provided, the user may also view intermediate response data that indicates a manner in which the response is generated. The intermediate response data may be any type of data that is used or generated in the process of generating an AI response. Various types of intermediate response data that may be provided include query data, context data (e.g., intent and skill), source data, query results data, and/or the like.

In some cases, the intermediate response data may be provided for display at the same time as the AI response. In other cases, the intermediate response data may be provided for display as the data is identified. For example, in accordance with identifying an intent and skill associated with an input prompt, the intent and skill may be provided to the user device as intermediate response data. Thereafter, in accordance with generating a query, the query may be provided to the user device. Accordingly, the intermediate response data may be provided for display in advance of generating and/or presenting the corresponding AI response.

The intermediate response data may be presented in any number of ways and formats. In some cases, the intermediate response data may be presented in a panel, window, or user interface portion separate from the AI response. Further, the intermediate response data may be accessible or viewable immediately, based on a selection to view such data, or other modifiable representation of the intermediate response data. For instance, in some cases, intermediate response data may be automatically presented in line or interleaved with the chat (e.g., interleaved between the user input prompt and the AI response). In other cases, a link or other indicator to view the intermediate response data may be presented. In accordance with a user selecting an intermediate response indicator (e.g., an icon or link), the user may be presented with the intermediate response data. In yet other cases, various types of intermediate response data may be expanded or accessed to view. For instance, an indication of a first type of intermediate response data (e.g., a query) and an indication of a second type of intermediate response data (e.g., raw query results) may be presented. Based on a user selection of the indication of the first type of intermediate response data, the corresponding intermediate response data may be expanded or presented. Similarly, based on a user selection of the indication of the second type of intermediate response data, the corresponding intermediate response data may be expanded. In contrast, the user may select to minimize or collapse the intermediate response data.

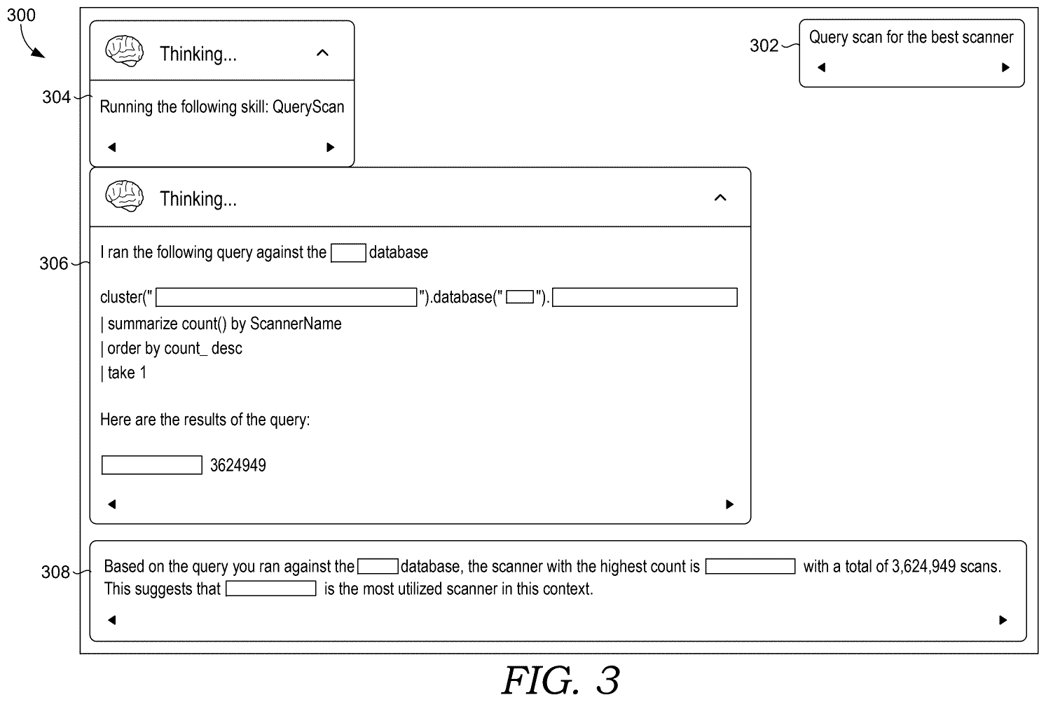

One example user interface presenting intermediate response data is provided in FIG. 3. As shown in FIG. 3, the user input prompt 302 is illustrated to “Query scan for the best scanner.” As the user input prompt 302 is being processed, a first intermediate response data 304 is presented indicating the identified skill as a “QueryScan.” The second intermediate response data 306 is also presented, indicating the generated query and the data source to search or being searched. Further, the second intermediate response data 306 includes the results of the query. The AI response 308 generated based on the intermediate response data 304 and 306 is also provided. As shown, the user may select to reduce or minimize the first intermediate response data 304 via collapse indicator 310 and/or select to reduce the second intermediate response data 306 via collapse indicator 312. As can be appreciated, intermediate response data may be visually presented or indicated in any number of ways, and is not limited to the examples provided herein. For instance, intermediate response data may be signified by a particular icon, an identifier (e.g., thinking), a color, or the like to signify to a user that the data is intermediate response data and/or that the final response is yet to come.

Returning to FIG. 2, the feedback manager 230 is generally configured to manage user feedback. User feedback may be obtained in association with intermediate response data to facilitate providing intermediate response data and/or AI responses in an effective and efficient manner. In this regard, a user may interact with a user interface to provide feedback in association with intermediate response data.

In some embodiments, a user may provide feedback indicating preferences related to the presentation of intermediate response data. User feedback may be provided in any number of ways. As one example, a user may input presentation-related preferences (e.g., via settings or user profile) in association with intermediate response data to provide feedback. As another example, a user may manipulate the presentation of the intermediate response data to provide feedback (e.g., collapse a particular type of intermediate response data, expand a particular type of intermediate response data, or select to delete a particular type or all of intermediate response data). The user feedback may correspond with a particular type of intermediate response data or all intermediate response data. User feedback related to presentation preferences may correspond with any type of format, style, or display of the intermediate response data. For instance, user feedback may relate to the extent or amount of data displayed, the type of data displayed, a location at which the data is displayed, a frequency at which to display the data, a number of times to display the data in association with a chat session, etc.

Based on the user feedback, the feedback manager 230 may facilitate modification of presentation of the intermediate response data (e.g., for a current AI response and/or subsequent AI responses). In some cases, the user feedback may be provided to the response manager 226 and/or the data provider 228 to facilitate subsequent presentation of intermediate response data in accordance with user preferences.

Additionally or alternatively, a user may provide feedback indicating preferences related to the utilization of intermediate response data. In this way, the user feedback may modify what type of intermediate response data is used to generate an AI response, or how intermediate response data is used (e.g., for a current AI response and/or subsequent AI response). Obtaining and using such user feedback in association with intermediate response data facilitates a more desired or tailored generation and/or presentation of data for the user, thereby providing a better user experience. Further, such feedback may further reduce utilization of computer resources that would otherwise be used to repetitively generate and/or display AI responses (e.g., in an effort to ensure the user trusts the response or obtains a desired response).

User feedback may be provided in any number of ways. As one example, a user may input utilization-related preferences (e.g., via settings or user profile) in association with intermediate response data to provide feedback. As another example, a user may edit intermediate response data or manipulate the presentation of the intermediate response data to provide feedback (e.g., provide an indication of a desire to not use a particular type of intermediate response data to generate an AI response). Any type of feedback related to utilization of intermediate response data may be provided. For instance, a user may provide an indication of a desire to not use a particular query, or a portion of a query. As another example, a user may indicate that an intent or skill should not be used or is inaccurate. In some cases, the user may select an appropriate intent or skill preferred for use in generating an AI response. As another example, a user may specify that a particular query result or data source should not be (or should be) used to generate an AI response. Such feedback may be particular to a current user input prompt and corresponding AI response, a current session, or any session for the user.

Based on the user feedback, the feedback manager 230 may facilitate modification of an AI response (e.g., for a current AI response and/or subsequent AI responses). In some cases, the user feedback may be provided to an appropriate component to adjust subsequent utilization of the intermediate response data. For example, assume a user indicates a preference to avoid a particular skill or intent. In such a case, the undesired particular skill can be provided to the context manager 222 such that the context manager 222 avoids identifying the particular skill or intent in a subsequent AI response generation (e.g., another AI response generation in the session, any subsequent AI response generation, or the like). As another example, an undesired query aspect or data source may be communicated to the query manager 224 to avoid subsequent generation of a similar query or use of the particular data source. As yet another example, an undesired query result, or source associated therewith, may be communicated to the response manager 226 to avoid identifying a similar query result or source, or to remove a similar query result or source for use in generating a subsequent AI response.

In some cases, such user feedback may be provided to use as a rule-based preference or stored in association with a user profile. In other cases, such user feedback may be provided for model training. For instance, a user preference may be provided to train an AI model, such as an LLM, that facilitates generating an AI response. In this way, user feedback may be used in training to customize AI responses over time, for instance, by providing more weight for certain intermediate response data (e.g., a first data source) and/or less weight for certain intermediate response data (e.g., a second data source). As another example, user feedback related to a query preference may be provided as training data to train a model (e.g., an LLM) used to generate a query.

As discussed, various implementations and combinations of technologies may be used to implement various aspects related to providing intermediate response data in association with AI responses. In some cases, the particular technologies employed may depend on the application utilizing such technologies.

### Exemplary Implementations for Providing Intermediate Response Data in Association With AI Responses

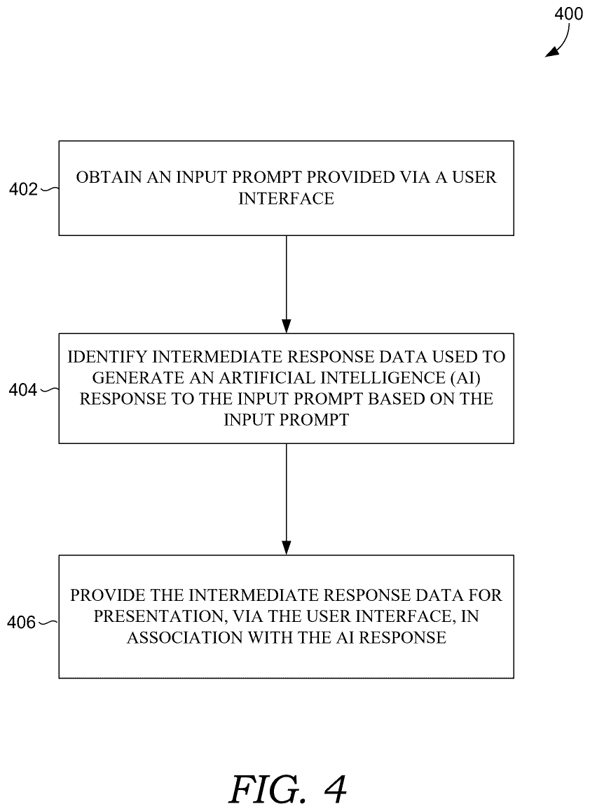

As described, various implementations can be used in accordance with embodiments described herein. FIGS. 4-6 provide methods of providing intermediate response data in association with AI responses, in accordance with embodiments described herein. The methods 400, 500, and 600 can be performed by a computer device, such as device 700 described below. The flow diagrams represented in FIGS. 4-6 are intended to be exemplary in nature and not limiting. For example, flow diagrams represented in FIGS. 4-6 represent various combinations of technologies and approaches used to manage providing intermediate response data in association with AI responses, but are not intended to reflect all combinations of technologies and approaches that may be used in accordance with embodiments described herein.

With respect to FIG. 4, FIG. 4 provides an example method flow 400 for providing intermediate response data in association with AI responses, in accordance with embodiments described herein. At block 402, an input prompt provided via a user interface is obtained. An input prompt may be a text input provided by a user associated with a user device. The text input may include a request for information or performance of a task.

At block 404, intermediate response data used to generate an artificial intelligence (AI) response to the input prompt is identified based on the input prompt. Intermediate response data may be of any type or form. As one example, intermediate response data may include an intent identified in association with the input prompt. As another example, intermediate response data may include a skill associated with the input prompt. A skill may be identified, from among a set of candidate skills, with each candidate skill corresponding with a function(s) to assist with performing a task. As yet another example, intermediate response data may include a query generated to obtain data relevant to the input prompt. A query may be generated using various data, including the input prompt, an identified intent, and/or an identified skill. As another example, intermediate response data may include a data source for which to provide a query to obtain data relevant to the input prompt. Additionally or alternatively, intermediate response data may include query results, such as raw search results obtained in response to executing a query.

At block 406, the intermediate response data is provided for presentation, via the user interface, in association with the AI response. In this way, a user that provided an input prompt may be presented with intermediate response data (e.g., a query, a query result, a data source, an intent, a skill, and/or the like) that is used in some manner to generate an AI response. In some cases, the intermediate response data is provided as the AI response is being generated. The intermediate response data may be concurrently presented with the AI response via the user interface. In some cases, the intermediate response data may be presented based on receiving a user selection to view the intermediate response data. For example, an indication that intermediate response data exists for a particular prompt may be presented (e.g., via a link or other indicator). The user may then select the indication to view intermediate response data. In some cases, each type and/or instance of intermediate response data may be represented separately such that a user may selectively view different types of intermediate response data.

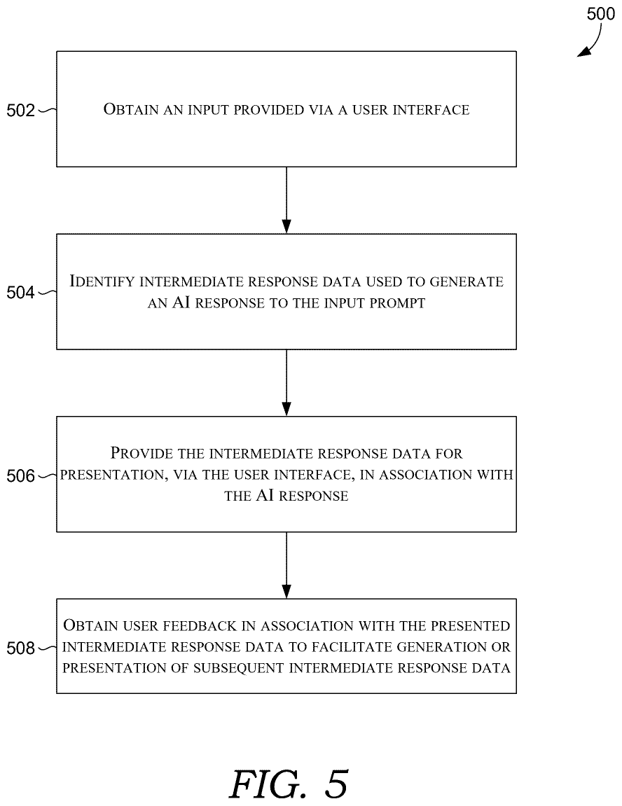

Turning to FIG. 5, FIG. 5 provides another example method flow 500 for providing intermediate response data in association with AI responses, in accordance with embodiments described herein. Initially, at block 502, an input provided via a user interface is obtained. For example, an input prompt may be a text input provided by a user associated with a user device. The text input may include a request for information or performance of a task.

At block 504, intermediate response data used to generate an AI response to the input prompt is identified based on the input prompt. In embodiments, the intermediate response data may be an intent, a skill, a query, a data source, and/or a query result. Any amount or type of intermediate response data is contemplated within the scope of embodiments described herein.

At block 506, the intermediate response data is provided for presentation, via the user interface, in association with the AI response. In this regard, the intermediate response data may be presented in association with the input prompt and/or the AI response to facilitate trustworthiness (e.g., of relevance or accuracy) of the AI response.

At block 508, user feedback in association with the presented intermediate response data is obtained to facilitate generation or presentation of subsequent intermediate response data. In some cases, the user feedback may be a presentation-related preference indicating a desired or undesired manner in which to present the intermediate response data. Alternatively or additionally, the user feedback may be a utilization-related preference indicating a desired or undesired manner in which to use the intermediate response data to generate an AI response. The user feedback may be used to train a model, such as an LLM, for subsequently identifying intermediate response data and/or generating a new AI response.

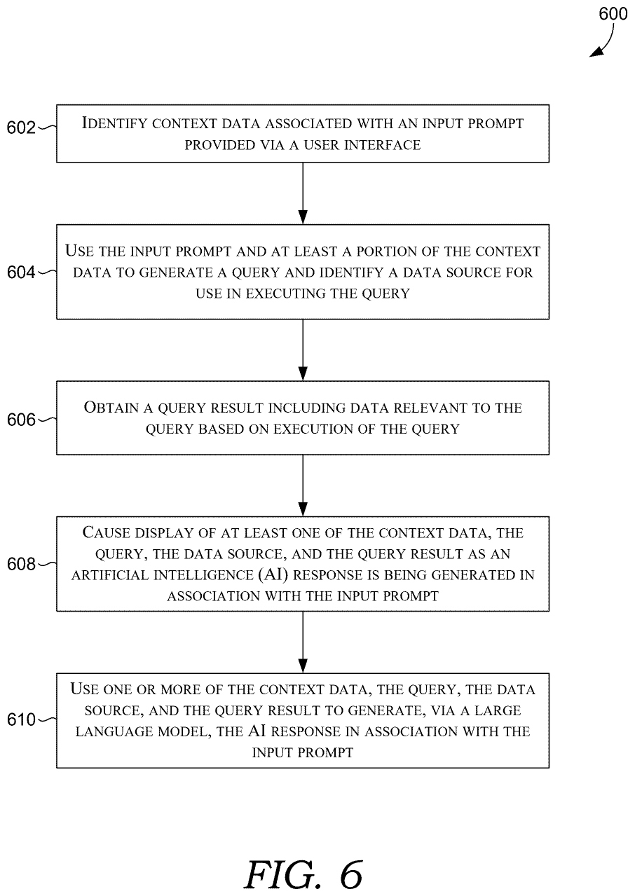

Turning to FIG. 6, FIG. 6 provides an example method flow 600 for providing intermediate response data in association with AI responses, in accordance with embodiments described herein. Initially, at block 602, context data associated with an input prompt provided via a user interface is identified. Context data may include an intent associated with the input prompt and/or a skill associated with the input prompt.

At block 604, the input prompt and at least a portion of the context data is used to generate a query and identify a data source for use in executing the query. In some embodiments, an LLM may be used to facilitate generating a query. Thereafter, at block 606, a query result including data relevant to the query is obtained based on execution of the query. In some cases, an API may be used to facilitate execution of the query. As one example, an API to a search engine may be called to execute the query and identify relevant data.

At block 608, at least one of the context data, the query, the data source, and the query result is caused to be displayed as an artificial intelligence (AI) response is being generated in association with the input prompt. In this way, a user may be provided with context or development as to the generation of an AI response. Any amount and any type of intermediate response data may be presented.

At block 610, one or more of the context data, the query, the data source, and the query result is used to generate, via a large language model, the AI response in association with the input prompt. For example, context data, a query, a data source, and/or a query result may be used to compile a response, via an LLM, suitable to present to the user. Thereafter, at block 612, the AI response is caused to be displayed.

Accordingly, various aspects of technology are directed to systems, methods, and graphical user interfaces for intelligently generating and using context briefs to identify relevant chat responses. It is understood that various features, subcombinations, and modifications of the embodiments described herein are of utility and may be employed in other embodiments without reference to other features or subcombinations. Moreover, the order and sequences of steps shown in the example methods 600, 700, and 800 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computing system is provided. The computing system can include a processor and computer storage memory having computer-executable instructions stored thereon that, when executed by the processor, configure the computing system to perform operations. In embodiments, the operations include obtaining an input prompt provided via a user interface. The operations further include, based on the input prompt, identifying intermediate response data used to generate an artificial intelligence (AI) response to the input prompt. The operations further include providing the intermediate response data for presentation, via the user interface, in association with the AI response. Advantageously, the intermediate response data provide insight into the manner in which an AI response is generated, thereby enabling a more trustworthy response and, as such, resulting in fewer searches for relevant data.

In any combination of the above embodiments of the computing system, the intermediate response data comprises an indication of an intent associated with the input prompt, wherein the intent is identified based on analyzing the input prompt.

In any combination of the above embodiments of the computing system, the intermediate response data comprises a skill associated with the input prompt, the skill corresponding with a function to assist with performing a task.

In any combination of the above embodiments of the computing system, the intermediate response data comprises a query generated to obtain data relevant to the input prompt.

In any combination of the above embodiments of the computing system, the intermediate response data comprises a data source for which to provide a query to obtain data relevant to the input prompt.

In any combination of the above embodiments of the computing system, the intermediate response data comprises query results obtained in response to executing a query generated, based on the input prompt, to obtain data relevant to the input prompt.

In any combination of the above embodiments of the computing system, the intermediate response data is provided as the AI response is being generated.

In any combination of the above embodiments of the computing system, the intermediate response data is provided for concurrent presentation with the AI response via the user interface.

In any combination of the above embodiments of the computing system, the intermediate response data is presented, via the user interface, based on receiving a user selection to view the intermediate response data.

In other embodiments, a computer-implemented method is provided. The method includes obtaining, via an artificial intelligence (AI) assistant manager, an input prompt provided via a user interface. The method also includes, based on the input prompt, identifying, via the AI assistant manager, intermediate response data used to generate an AI response to the input prompt. The method also includes providing, via the AI assistant manager, the intermediate response data for presentation, via the user interface, in association with the AI response. The method further includes obtaining user feedback in association with the presented intermediate response data to facilitate generation or presentation of subsequent intermediate response data. Advantageously, the intermediate response data provide insight into the manner in which an AI response is generated, thereby enabling a more trustworthy response and, as such, resulting in fewer searches for relevant data.

In any combination of the above embodiments of the computer-implemented method, the intermediate response data comprises an intent, a skill, a query, a data source, and/or a query result.

In any combination of the above embodiments of the computer-implemented method, the user feedback comprises a presentation-related preference indicating a desired or undesired manner in which to present the intermediate response data.

In any combination of the above embodiments of the computer-implemented method, the user feedback comprises a utilization-related preference indicating a desired or undesired manner in which to use the intermediate response data to generate the AI response.

In any combination of the above embodiments of the computer-implemented method, the method further includes using the user feedback to train a large language model for subsequently generating a new AI response.

In any combination of the above embodiments of the computer-implemented method, the intermediate response data is presented interleaved between the input prompt and the AI response.

In other embodiments, one or more computer storage media having computer-executable instructions embodied thereon that, when executed by one or more processors, cause the one or more processors to perform a method is provided. The method includes identifying context data associated with an input prompt provided via a user interface. The method also includes using the input prompt and at least a portion of the context data to generate a query and identify a data source for use in executing the query. The method also includes, based on execution of the query, obtaining a query result including data relevant to the query. The method further includes causing display, via the user interface, of at least one of the context data, the query, the data source, and the query result as an artificial intelligence (AI) response is being generated in association with the input prompt. The method further includes using one or more of the context data, the query, the data source, and the query result to generate, via a large language model, the AI response in association with the input prompt. The method also includes causing display, via the user interface, of the AI response. Advantageously, the intermediate response data provide insight into the manner in which an AI response is generated, thereby enabling a more trustworthy response and, as such, resulting in fewer searches for relevant data.

In any combination of the above embodiments of the media, the context data comprises an intent associated with the input prompt and/or a skill associated with the input prompt.

In any combination of the above embodiments of the media, the method further includes obtaining user feedback associated with the display of the at least one of the context data, the query, the data source, and the query result.

In any combination of the above embodiments of the media, the method further includes using the user feedback to modify the display of the at least one of the context data, the query, the data source, and the query result.

In any combination of the above embodiments of the media, the method further includes using the user feedback to modify generation and/or presentation of a subsequently generated set of intermediate response data or a subsequently generated AI response.

### Overview of Exemplary Operating Environments

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 7 in particular, an exemplary operating environment for implementing aspects of the technology described herein is shown and designated generally as computing device 700. Computing device 700 is just one example of a suitable computing environment and is not intended to suggest any limitation as to the scope of use or functionality of the technology described herein, and nor should the computing device 700 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, an illustrative power supply 722, and a radio(s) 724. Bus 710 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The diagram of FIG. 7 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or non-volatile memory. The memory 712 may be removable, non-removable, or a combination thereof. Exemplary memory includes solid-state memory, hard drives, and optical-disc drives. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, and vibrating component. I/O port(s) 718 allow computing device 700 to be logically coupled to other devices including I/O components 720, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include radio(s) 724. The radio 724 transmits and receives radio communications. The computing device may be a wireless terminal adapted to receive communications and media over various wireless networks. Computing device 700 may communicate via wireless protocols, such as code-division multiple access (“CDMA”), Global System for Mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Turning to FIG. 8, FIG. 8 is a block diagram of a language model 800 (for example, a BERT model or Generative Pre-trained Transformer [GPT]-4 model) that uses particular inputs to make particular predictions (for example, answers to questions), according to some embodiments. In one embodiment, the language model 800 corresponds to the response generator 224 of FIG. 2 described herein. In various embodiments, the language model 800 includes one or more encoders and/or decoder blocks 806 (or any transformer or portion thereof).

First, a natural language corpus (for example, various WIKIPEDIA English words or BooksCorpus) of the inputs 801 are converted into tokens and then feature vectors and embedded into an input embedding 802 to derive meaning of individual natural language words (for example, English semantics) during pre-training. In some embodiments, to understand English language, corpus documents, such as text books, periodicals, blogs, social media feeds, and the like are ingested by the language model 800.

In some embodiments, each word or character in the input(s) 801 is mapped into the input embedding 802 in parallel or at the same time, unlike existing long short-term memory (LSTM) models, for example. The input embedding 802 maps a word to a feature vector representing the word. But the same word (for example, “apple”) in different sentences may have different meanings (for example, brand versus fruit). This is why a positional encoder 804 can be implemented. A positional encoder 804 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$$P {E}_{( p o s , 2 i )} = sin ( pos / 1000 {0}^{2 i / {d}_{m o d e l}} ) \qquad ( 1 )$$

$$P {E}_{( p o s , 2 i + 1 )} = cos ( pos / 1000 {0}^{2 i / {d}_{m o d e l}} ) \qquad ( 2 )$$

After passing the input(s) 801 through the input embedding 802 and applying the positional encoder 804, the output is a word embedding feature vector, which encodes positional information or context based on the positional encoder 804. These word embedding feature vectors are then passed to the encoder and/or decoder block(s) 806, where it goes through a multi-head attention layer 806-1 and a feedforward layer 806-2. The multi-head attention layer 806-1 is generally responsible for focusing or processing certain parts of the feature vectors representing specific portions of the input(s) 801 by generating attention vectors. For example, in Question-Answering systems, the multi-head attention layer 806-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = softmax ( \frac{Q \cdot {K}^{T}}{\sqrt{Dimension of vector Q , K or V}} ) . V . \qquad ( 3 )$$

For multi-headed attention, there are multiple weight matrices W^{q}, W^{k}, and W^{v}, so there are multiple attention vectors Z for every word. However, a neural network may expect one attention vector per word. Accordingly, another weighted matrix, W^{z}, is used to make sure the output is still an attention vector per word. In some embodiments, after the layers 806-1 and 806-2, there is some form of normalization (for example, batch normalization and/or layer normalization) performed to smoothen out the loss surface, making it easier to optimize while using larger learning rates.

Layers 806-3 and 806-4 represent residual connection and/or normalization layers where normalization recenters and rescales or normalizes the data across the feature dimensions. The feedforward layer 806-2 is a feedforward neural network that is applied to every one of the attention vectors outputted by the multi-head attention layer 806-1. The feedforward layer 806-2 transforms the attention vectors into a form that can be processed by the next encoder block or make a prediction at 808. For example, given that a document includes a first natural language sequence “the due date is . . . ,” the encoder/decoder block(s) 806 predicts that the next natural language sequence will be a specific date or particular words based on past documents that include language identical or similar to the first natural language sequence.

In some embodiments, the encoder/decoder block(s) 806 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 806 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 801 may be various historical documents, such as text books, journals, and periodicals, in order to output the predicted natural language characters in 808 (not make the predictions at runtime or prompt engineering at this point). The example encoder/decoder block(s) 806 takes in a sentence, paragraph, or sequence (for example, included in the input[s] 801), with random words being replaced with masks. The goal is to output the value or meaning of the masked tokens. For example, if a line reads, “please [MASK] this document promptly,” the prediction for the “mask” value is “send.” This helps the encoder/decoder block(s) 806 understand the bidirectional context in a sentence, paragraph, or line at a document. In the case of NSP, the encoder/decoder block(s) 806 takes, as input, two or more elements, such as sentences, lines, or paragraphs, and determines, for example, if a second sentence in a document actually follows (for example, is directly below) a first sentence in the document. This helps the encoder/decoder block(s) 806 understand the context across all the elements of a document, not just within a single element. Using both of these together, the encoder/decoder block(s) 806 derives a good understanding of natural language.

In some embodiments, during pre-training, the input to the encoder/decoder block(s) 806 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 802). At the output side is the binary output for the next sentence prediction. For example, this component may output 1, for example, if masked sentence 2 follows (for example, is directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 802) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 801) that are encoded into a vector (for example, first sentence, second sentence, and so forth, assuming a top-down and right-to-left approach). The position embeddings are vectors that represent the position of a particular word in such a sentence that can be produced by positional encoder 804. When these three embeddings are added or concatenated together, an embedding vector is generated that is used as input into the encoder/decoder block(s) 806. The segment and position embeddings are used for temporal ordering since all of the vectors are fed into the encoder/decoder block(s) 806 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 806 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 806 processing the inputs 803A and/or 803B in order to make the predictions and generate a prompt response, as indicated in 804. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

The technology described herein has been described in relation to particular aspects, which are intended in all respects to be illustrative rather than restrictive.

What is claimed is:

1. A computing system comprising:
a processor; and
computer storage memory having computer-executable instructions stored thereon that, when executed by the processor, configure the computing system to perform operations comprising:
obtaining an input prompt provided via a user interface;
based on the input prompt, identifying intermediate response data used to generate an artificial intelligence (AI) response to the input prompt; and
providing the intermediate response data for presentation, via the user interface, in association with the AI response.

2. The computing system of claim 1, wherein the intermediate response data comprises an indication of an intent associated with the input prompt, wherein the intent is identified based on analyzing the input prompt.

3. The computing system of claim 1, wherein the intermediate response data comprises a skill associated with the input prompt, the skill corresponding with a function to assist with performing a task.

4. The computing system of claim 1, wherein the intermediate response data comprises a query generated to obtain data relevant to the input prompt.

5. The computing system of claim 1, wherein the intermediate response data comprises a data source for which to provide a query to obtain data relevant to the input prompt.

6. The computing system of claim 1, wherein the intermediate response data comprises query results obtained in response to executing a query generated, based on the input prompt, to obtain data relevant to the input prompt.

7. The computing system of claim 1, wherein the intermediate response data is provided as the AI response is being generated.

8. The computing system of claim 1, wherein the intermediate response data is provided for concurrent presentation with the AI response via the user interface.

9. The computing system of claim 1, wherein the intermediate response data is presented, via the user interface, based on receiving a user selection to view the intermediate response data.

10. A computer-implemented method comprising:
obtaining, via an artificial intelligence (AI) assistant manager, an input prompt provided via a user interface;
based on the input prompt, identifying, via the AI assistant manager, intermediate response data used to generate an AI response to the input prompt;
providing, via the AI assistant manager, the intermediate response data for presentation, via the user interface, in association with the AI response; and
obtaining user feedback in association with the presented intermediate response data to facilitate generation or presentation of subsequent intermediate response data.

11. The computer-implemented method of claim 10, wherein the intermediate response data comprises an intent, a skill, a query, a data source, and/or a query result.

12. The computer-implemented method of claim 10, wherein the user feedback comprises a presentation-related preference indicating a desired or undesired manner in which to present the intermediate response data.

13. The computer-implemented method of claim 10, wherein the user feedback comprises a utilization-related preference indicating a desired or undesired manner in which to use the intermediate response data to generate the AI response.

14. The computer-implemented method of claim 10 further comprising using the user feedback to train a large language model for subsequently generating a new AI response.

15. The computer-implemented method of claim 10, wherein the intermediate response data is presented interleaved between the input prompt and the AI response.

16. One or more computer storage media having computer-executable instructions embodied thereon that, when executed by one or more processors, cause the one or more processors to perform a method, the method comprising:
identifying context data associated with an input prompt provided via a user interface;
using the input prompt and at least a portion of the context data to generate a query and identify a data source for use in executing the query;
based on execution of the query, obtaining a query result including data relevant to the query;
causing display, via the user interface, of at least one of the context data, the query, the data source, and the query result as an artificial intelligence (AI) response is being generated in association with the input prompt;
using one or more of the context data, the query, the data source, and the query result to generate, via a large language model, the AI response in association with the input prompt; and
causing display, via the user interface, of the AI response.

17. The media of claim 16, wherein the context data comprises an intent associated with the input prompt and/or a skill associated with the input prompt.

18. The media of claim 16 further comprising obtaining user feedback associated with the display of the at least one of the context data, the query, the data source, and the query result.

19. The media of claim 18 further comprising using the user feedback to modify the display of the at least one of the context data, the query, the data source, and the query result.

20. The media of claim 18 further comprising using the user feedback to modify generation and/or presentation of a subsequently generated set of intermediate response data or a subsequently generated AI response.
